(19) United States
(12) Patent Application Publication
(10) Pub. No.: US 2017/0120290 A1
(43) Pub. Date: May 4, 2017

(54) APPARATUS AND METHOD FOR PRODUCING NANOFIBERS FROM AN ARRAY OF TWO PHASE FLOW NOZZLES

(71) Applicants: Larry Marshall, Chesterfield, VA (US); Michael Bryner, Midlothian, VA (US); Michael Burt, Chesterfield, VA (US)

(72) Inventors: Larry Marshall, Chesterfield, VA (US); Michael Bryner, Midlothian, VA (US); Michael Burt, Chesterfield, VA (US)

(73) Assignee: VERDEX TECHNOLOGIES INC., Richmond, VA (US)

(21) Appl. No.: 14/929,406

(22) Filed: Nov. 1, 2015

(51) Int. Cl. B05D 1/02

(52) U.S. Cl. CPC B05D 1/02; B05D 2201/02

(57) ABSTRACT

Apparatus for forming and fibrillating a molten polymeric film into nanofibers consisting of a plurality of two-phase flow spinning nozzles arranged in a substantially liner array each nozzle into nanofibers including one or more first input orifices for a process gas; one or more second input orifices for a polymer melt; a flow channel including two or more channel walls and a monotonically decreasing flow area wherein the process gas and polymer melt are combined into a stratified two phase flow with the polymer melt formed into a film on one or more of the channel walls; and one or more channel exit openings, each exit opening including an edge at which the process gas reaches sonic velocity or less and where the edge is configured to fibrillate the polymeric film into a stream of nanofibers.

### FIELD OF THE DISCLOSURE

This disclosure relates to an array of two-phase flow nozzles for spinning nanofibers

### BACKGROUND OF THE INVENTION

Manufacturing processes in which a material is formed by propelling a fluid composition from a nozzle by way of a fluid jet upon which the material solidifies into a desired form are known in the art. U.S. Pat. No. 8,666,854 discloses a film fibrillation process and apparatus for producing nanofibers a two-phase gas/polymer fluid mixture. The polymer and gas flow in the same channel. The gas flow spreads the polymer into a thin film. The thin film is fibrillated aerodynamically at the channel exit. Fiber fineness correlates with film thickness. All nozzles disclosed are axisymmetric. All nozzles disclosed have an annular channel with a decreasing annular radius in the direction of flow. This advantageously facilitates forming a single fiber forming air stream exiting the nozzle. However, it also reduces the wetted flow area in the direction of flow over which the polymer film flows causing it to thicken. The result is a wide distribution of fiber sizes with some larger microfibers being produced together with the finer nanofibers. This type of broad fiber size distribution is especially useful when seeking to produce a lofty fibrous web where the larger fibers provide resistance to compression. There is however a need for processes which can produce fibrous webs with a narrower range of fiber sizes.

U.S. Pat. No. 8,880,594 discloses coform fibrous materials and a method for making same using a modification to the axisymmetric nozzle design of U.S. Pat. No. 8,668,854. A flared nozzle provides a hollow annular channel, the center channel of which allows secondary materials to be aspirated into the air stream exiting the nozzle. The flared nozzle design is configured to provide an increased area of wetted flow to the polymer film in the direction of flow. This has the advantage of geometrically thinning the film as it moves down the two phase flow channel resulting in finer fibers. The flared design does not produce an aerodynamically coherent air stream exiting the nozzle.

The axisymmetric designs of the prior art are not easily adapted to scale up to multiple nozzles for producing wide uniform nonwoven webs.

In nozzle designs of the prior art, median fiber diameter is a function of polymer flow rates. Increasing polymer flow rates results in increases in fiber sizes. In film fibrillation processes, the polymer film thickens with increased flow rates and fibrillates into larger individual fibers. This has limited the industrial utility of nanofiber fabrication methods.

There is a need for a fiber spinning process an apparatus which incorporates both a gas driven fluid mixture and a geometric thinning of the polymer film to produce the finest possible fibers with a narrow diameter distribution.

There is also a need for a spinning nozzle design that can easily be scaled to provide uniform deposition of fibers across a conventional collection belt to create uniform nonwoven web.

There is further a need for methods for producing nanofibers at high flow rates.

There is also a need for methods for producing fine fibers at lower air flow rates.

### SUMMARY OF THE INVENTION

The objective of the present disclosure is to provide a scalable apparatus composed of two-phase flow spinning nozzles that will combine a gas-polymer stratified two-phase flow into a thin polymer film and fibrillate the polymer film into nanofibers which can be uniformly deposited across a conventional collection belt to create nonwoven nanofibrous webs.

The current disclosure teaches a two-phase flow nozzle for forming and fibrillating a molten polymeric film into nanofibers including one or more first input orifices for a process gas; one or more second input orifices for a polymer melt; a flow channel including two or more channel walls and a monotonically decreasing flow area wherein the process gas and polymer melt are combined into a stratified two phase flow with the polymer melt formed into a film on one or more of the channel walls; one or more channel exit openings, each exit opening comprising an edge at which the process gas reaches sonic velocity or less and wherein the edge is configured to fibrillate the polymeric film into a stream of nanofibers.

In another embodiment, spacing of the polymer input orifices is configured so as to spread the film in a direction transverse to the flow direction as well as in the flow direction, thereby thinning the film.

In yet another embodiment, flow chamber geometry is configured to spread the film over an angle greater than thirty degrees.

In still another embodiment of the apparatus, the channel exit opening comprises grooves configured to split the polymer film into a plurality of individual polymer streams.

In yet another embodiment of the apparatus, the channel exit opening increases wetted polymer flow area further thinning the polymer film by geometrical modifications comprising grooves, sawtooths, sinusoids, ellipsoids, square waves, rectangular waves, pulse waves and triangular waves.

In still another embodiment, nanofibers cross section is not circular.

The current disclosure also teaches an apparatus for forming and fibrillating a molten polymeric film into nanofibers including a plurality of two-phase flow spinning nozzles arranged in a substantially linear array each nozzle including one or more first input orifices for a process gas; one or more second input orifices for a polymer melt, a flow channel comprising two or more walls where the process gas and polymer melt are combined into a stratified two phase flow with the polymer melt formed into a film on one or more of the channel walls; one or more channel exit openings, each exit including an edge at which the process gas reaches sonic velocity or less and wherein the channel exit opening edge is configured to fibrillate the polymeric film into a stream of nanofibers.

In one aspect of the apparatus, mass ratio of air flow rate to polymer flow rate required to produce nanofibers is less than about 50.

In another aspect of the apparatus, the apparatus is configured to produce non-woven nanofibers at flow rates greater than 1 gram per minute per centimeter.

In one embodiment, the apparatus includes a moving surface positioned at a set distance from the exit opening edge of the flow channel for collecting the nanofibers

The disclosure also teaches a process for forming and fibrillating a molten polymeric film into nanofibers using a substantially linear array of two-phase flow nozzles the process including the steps of introducing a process gas into one or more first orifices of each nozzle; introducing a polymer melt into one or more second orifices of each nozzle; combining the process gas and polymer melt in a stratified two phase flow inside a flow channel comprising two or more channel walls and one or more channel exit openings, each exit opening comprising an edge, wherein the flow channel has a monotonically decreasing flow area; forming a polymer film on one or more of the channel walls; accelerating the process gas to sonic velocity or less and fibrillating the polymer film at the exit opening edge into a stream of nanofibers.

In one aspect of the process, spacing of the polymer input orifices is configured so as to spread the polymer film in a direction transverse to the flow direction as well as in the flow direction, thereby thinning the film.

In another aspect of the process, flow chamber geometry is configured to spread the polymer film over an angle greater than thirty degrees.

In still another aspect of the process, the channel opening comprises grooves configured to split the polymer film into a plurality of individual polymer streams.

In yet another aspect of the process, the channel exit opening increases the wetted polymer flow area further thinning the polymer film by geometrical modifications selected from the list comprising grooves, sawtooths, sinusoids, ellipsoids, square waves, rectangular waves, pulse waves and triangular waves.

In yet another aspect of the process of the disclosure, nanofibers cross section is not circular.

In an aspect of the process of the disclosure, mass ratio of air flow rate to polymer flow rate required to produce nanofibers is less than about 50.

In another aspect of the disclosed process, the nanofibers are produced at a rate of at least 1 gram per minute per centimeter.

In still another aspect of the disclosure, the process comprises the step of collecting the nanofibers on a moving surface positioned at a set distance from the exit opening edge of the flow channel.

In a further embodiment, the disclosure provides a method and apparatus for producing a non-woven fibrous web with high uniformity, high porosity, small pore size and high surface area.

In various exemplary embodiments, the spin nozzle, apparatus, and method of the present disclosure may permit production of nonwoven fibrous webs containing nanofibers with a narrow distribution in fiber diameter. Other exemplary embodiments of the present disclosure may have structural features that enable their use in a variety of applications; may have exceptional absorbent and/or adsorbent properties; may have exceptional thermal resistance, may exhibit high porosity, high fluid permeability, and/or low pressure drop when used as a fluid filtration medium and may be manufactured in a cost-effective and efficient manner.

In other exemplary embodiments, the disclosure provides a process and apparatus for the production of relatively strong composite nanofibrous webs of discontinuous fibers made of polymeric materials for use as high efficiency filtration media to purify water and other fluids.

In other exemplary embodiments, the disclosure provides an apparatus and method to make high efficiency polymeric composite filtration media incorporating nanofibers which incur relatively low pressure losses associated with the flow of water and other liquids through such media.

In still further embodiments, the disclosure provides a process and apparatus for the production of relatively strong composite fibrous webs of discontinuous nanofibers.

Another aspect of the invention is to provide a more efficient means to spin nanofibers via film fibrillation from polymer melt using a heated gas stream as the working fluid.

Another aspect of the invention is to provide a spinning nozzle which allows for precise control of the exit gap which assures a very thin film, and minimizes the gas flow requirement for fine fiber production.

Another aspect of the invention is to provide a high throughput means to convert a single melt feed stream to nanofibers.

Another aspect of the invention is to provide a nanofiber spinning process with minimal air consumption.

Another aspect of the invention is to provide a two phase flow nozzle with an aerodynamically coherent air stream exiting the nozzle such that the fiber containing air stream can be blended with the exit streams of other nozzles.

Another aspect of the invention is to provide a spin nozzle design that can easily be scaled with multiple nozzles comprising a spin beam which can deposit fibers uniformly across a conventional collection belt to create uniform nonwoven web.

Another aspect of the invention is to provide a spin nozzle that facilitates activating or shutting down spin beam segments to allow production of nonwoven webs of varied widths.

Another aspect of the invention is to provide a spin nozzle design that facilitates fiber and web functionalization by adding particulates via coforming capability.

Various aspects and advantages of exemplary embodiments of the present disclosure have been summarized. The above summary is not intended to fully describe or limit each illustrated embodiment or every implementation of the present disclosure. The Drawings and the Detailed Description that follow more particularly exemplify certain preferred embodiments using the principles disclosed herein.

### BRIEF DESCRIPTION OF THE DRAWINGS

FIG. 1 is a perspective view an embodiment of the flow channel.

FIG. 2 is a cross section view of an embodiment of the flow channel.

FIG. 3A is front view of an embodiment of the flow channel.

FIG. 3B is another cross section view of an embodiment of the flow channel.

FIG. 4 illustrates the nominal relationships of the flow channel geometry

FIG. 5 illustrates an embodiment of a linear array of two-phase flow nozzles

FIG. 6 shows a plan view of a flow channel plate with flow channels

FIG. 7 shows spinning beams comprising several spinning beam modules

FIG. 8 shows an embodiment of the spinning beams configured for creating nonwovens containing functional particulates

FIG. 9A illustrates a first embodiment of a flow channel orientation

FIG. 9B illustrates a second embodiment of a flow channel orientation

FIG. 9C illustrates a third embodiment of a flow channel orientation

FIG. 9D illustrates a fourth embodiment of a flow channel orientation

FIG. 10 illustrates a machine direction view of a second embodiment of a two phase flow nozzle array

FIG. 11 illustrates a section view in the cross direction of a second embodiment of a two phase flow nozzle array

FIG. 12 illustrates a section view in the machine direction of a second embodiment of a two phase flow nozzle array

FIG. 13 illustrates a third embodiment of a two phase flow nozzle array in the machine direction

FIG. 14 illustrates a third embodiment of a nozzle array in the cross direction

FIG. 15 illustrates a section view in the machine direction of a second embodiment of a two phase flow nozzle array

FIG. 16 illustrates another section view in the machine direction of a second embodiment of a two phase flow nozzle array

FIG. 17 shows a cross-section of an embodiment of a two phase flow nozzle

FIG. 18 illustrates an embodiment of the nozzle edge geometry

FIG. 19 illustrates another embodiment of the nozzle edge geometry

FIG. 20 is a section view of another embodiment of a two phase flow nozzle

FIG. 21 illustrates still another embodiment of the nozzle edge geometry

FIG. 22 is a photograph illustrating flow channels being split into smaller

FIG. 23 is an SEM illustrating non circular nanofibers formed by the nozzle

FIG. 24A is an SEM of fibers produced in a first example

FIG. 24B is the fiber distribution of the nanofibers in the first example

FIG. 25A is an SEM of fibers produced in a second example

FIG. 25B is the fiber distribution of the nanofibers in the second example

FIG. 26A is an SEM of fibers produced in a third example

FIG. 26B is the fiber distribution of the nanofibers in the third example

FIG. 27 shows the fiber size distribution in fourth example at 269 C

FIG. 28 show the fiber size distribution in fourth example at 295 C

FIG. 29 show the fiber size distribution in fourth example at 313 C

FIG. 30 show the fiber size distribution in fourth example at 314 C

### DEFINITIONS

“Two Phase Flow Nozzle” means a spinning nozzle where a process gas and a polymer melt are introduced and combined into a two-phase gas-polymer flow.

“Substantially Linear” means a rectangle enclosing the element or a projection of the element has a length to width ratio of 2 or greater.

“Flow Channel” means a duct or passage wherein polymer melt and process gas flow simultaneously as a stratified two phase flow in a manner that produces a thin polymer film which forms fibers upon exiting the duct or passage.

“Spinning Beam” means an assembly of fiber forming flow channels configured to issue a substantially linear spatial array of fibers as across a web forming collector.

Spreading Angle” means the angle defined by 2 times the angle whose tangent is ½ the width of the lateral spread of the polymer film exiting the fiber forming flow channel divided by the centerline distance of the flow exit from the point of polymer entry.

### DETAILED DESCRIPTION OF THE INVENTION

### Apparatus and System

Disclosed herein is a process and apparatus for the formation of fine fibers and nanofibers by means of film fibrillation of a two-phase polymer-gas flow. Without being bound by theory, the apparatus combines a polymer melt stream and a process gas stream as a working fluid in a single flow channel to form a stratified two phase flow. The process gas stream is introduced into the flow channel at the channel entrance through a first orifice. The polymer melt is introduced at the wall of the flow channel near the channel entrance through a second orifice and is moved through the channel by gas pressure and the shearing force of the gas flow. It has been unexpectedly been found that a shearing gas flow can be configured to thin a polymer-gas film transversally to the direction of flow as well as in the direction of flow, resulting in a uniform distribution of nanofibers. In various embodiments, a spinning nozzle extrudes a stratified polymer-gas two phase flow to a thin polymer film into a flow channel configured to spread the polymer film in the direction of flow to a total angle of from 30 to 60 degrees from its source. Multiple adjacent nozzles may be combined into a pack assembly providing for a uniform distribution of nanofibers across the width of a web forming apparatus.

In an embodiment of the disclosure, the flow channel is constructed with a monotonically decreasing flow area to accelerate the gas and polymer flows in a manner which spreads the polymer film not only in the direction of flow, but in a direction transverse to the general flow direction resulting in advantageous additional thinning of the polymer film. The stratified two phase flow exits the flow channel at a downstream exit end comprising a thin, substantially linear slot or gap. The gas velocity is high enough to induce fiber formation via film fibrillation immediately as the combined flow leaves the flow channel and enters free space. It is believed that the fineness of the resulting fibers is determined by the thinness of the polymer film. The innovative transverse spreading and thinning of the film in addition to thinning in the flow direction result in a surprisingly efficient means of producing sub-micron nanofibers as shown in the examples below.

### First Embodiment

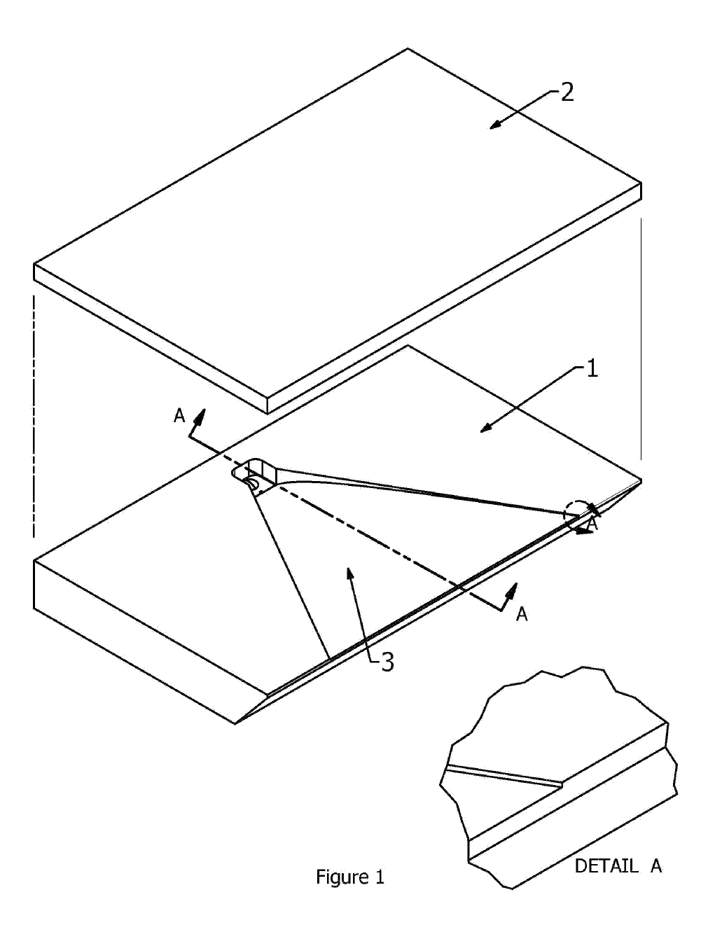

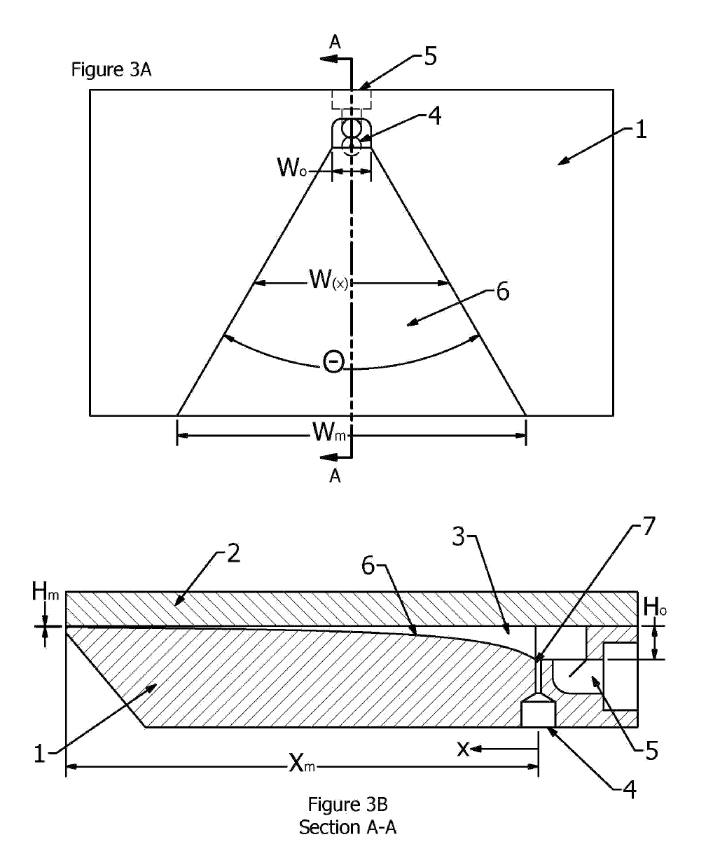

An embodiment of the flow channel is illustrated in FIGS. 1, 2, and 3. The flow channel is formed between the flow channel plate 1 and the flow channel lid 2. It has an narrow inlet section and a wide exit section with a contoured film spreading surface 3. Detail A of FIG. 1 shows a small step formed in the flow channel plate at the exit end which when covered by cover plate 1 forms an exit slot or gap of width, Wm, and height, Hm.

The process gas flow enters the apparatus through an entrance 5 and flows to the channel entrance chamber 6. The entrance chamber has width, Wo, and a height, Ho. The polymer melt enters through the polymer port 6 and flows through a metering capillary 7 into the entrance chamber 6 from which it is forced by the gas flow to flow and spread along a spreading surface 3 following the contour 8.

The flow channel geometry is designed such that the flow area for the stratified two phase flow of gas and polymer melt monotonically decreases from the channel entrance as follows: Channel width, W, and channel height, H, both change and are function of X, the centerline distance from the channel entrance, hence, W(x) and H(x). The channel width, W(x), increases according to a function which is chosen to be compatible with combined polymer and gas fluid mechanics so as to spread the gas and polymer flows together and without flow anomalies such as recirculation zones. If the channel width increases too rapidly or too much, the polymer film may not follow or adequately cover the spreading surface. The result can be undesirable distributions of fibers both in size and spatially. The efficient use of process gas can suffer also as some gas will bypass the areas covered with polymer film. For the examples herein, the channel width. W(x), increases linearly with X according to a spreading angle, θ.

The channel flow area, A(x), is assigned a monotonically decreasing function of X. For the examples herein, the channel flow area, A(x), decreases linearly with distance X. Since the channel flow area is given by the product of channel width and height, W(x)*H(x), specifying the channel width and area determines the channel height at any distance, X, from the channel entrance resulting in the contour 8 of the spreading surface.

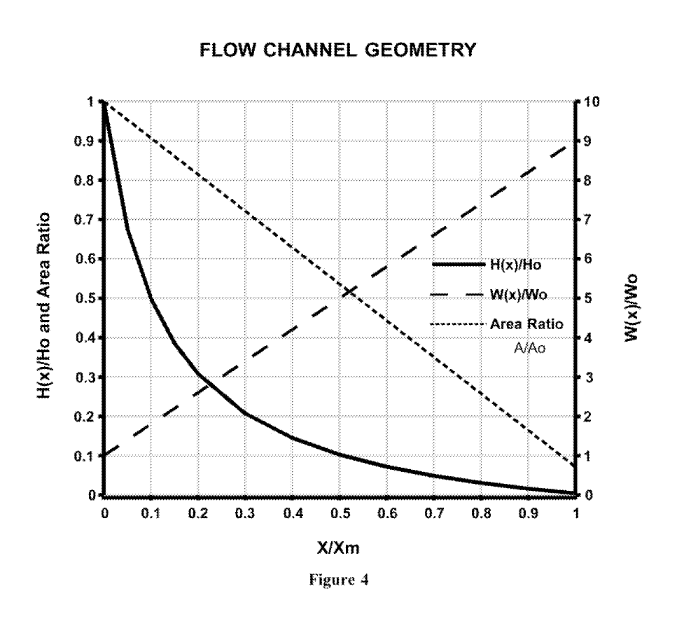

FIG. 4 illustrates graphically the nominal relationships of the flow channel geometry used in Examples 1, 2 and 3 below. Here Ho=0.635 cm (0.25 in), Hm=0.005 cm (0.002 in), Wo=0.635 cm (0.25 in), Wm=5.72 cm (2.25 in), with spreading angle θ=60 degrees, and Xm=4.40 cm (1.73 in). The diameter metering capillary 7 was 0.0508 cm (0.020 in).

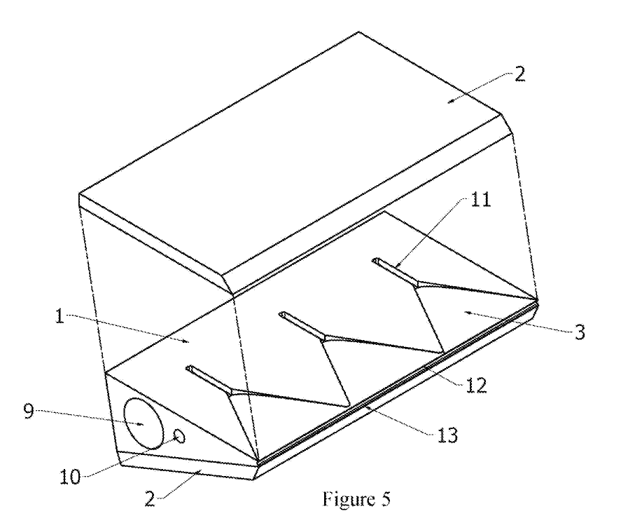

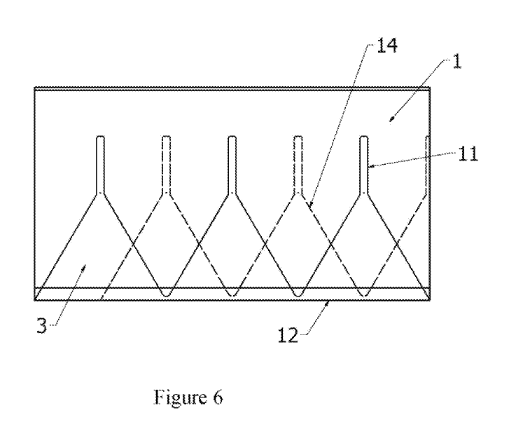

FIG. 5 shows one means of configuring multiple fiber forming flow channels to form a fiber spinning beam. Here multiple fiber forming flow channels on both sides of the beam comprising plates 1 with machined spreading surfaces 3 and lids 2 are arranged to produce fibers in a substantially linear, planar array. Those skilled in the art will know that each of the flow channels of such a configuration can be appropriately supplied with process gas through a central gas supply channel 9 and with polymer melt through a central polymer supply channel 10. Process gas and polymer enter each flow cell in a flow channel entrance 11. Polymer films exit the flow cells in a contiguous plane comprising adjacent cells 12 and 13. Fibers are subsequently formed in a substantially linear spatial array of fibers forwarded by a substantially planar gas jet. FIG. 6 shows a plan view of a flow channel plate with flow channels on the visible side, denoted by solid lines, having an entrance chamber 11 a spreading surface 3, and exits along the exit plane 12 with an identical set of channels on the hidden side, denoted by dashed lines, but offset from the first set. The offset is desirable to assure that any irregular fiber distributions due to cell repeat patterns on one side are compensated for by the cells on the other side, thereby assuring greater uniformity of fiber distribution in the planer flow issuing from the spinning beam. The planar gas jet and the array of fibers are well suited to depositing fibers uniformly across a fiber collector to form a uniform non-woven web.

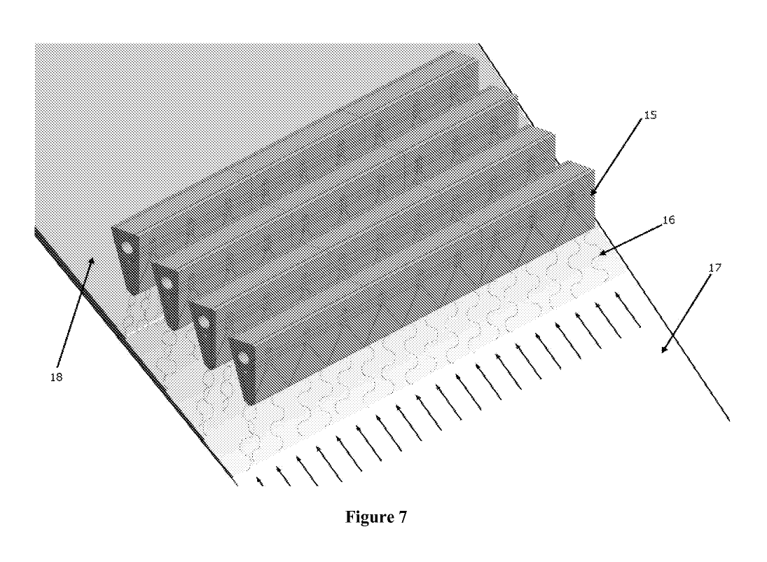

FIG. 7 shows spinning beams 15 each beam comprising several spinning beam modules of FIG. 5, as they might be installed on a web forming machine. Each spinning beam issues fibers 16 which are collected on a collector surface moving in a machine direction under the spinning beam array. The composite of deposited fiber overlays from each spinning beam form the non-woven web 18.

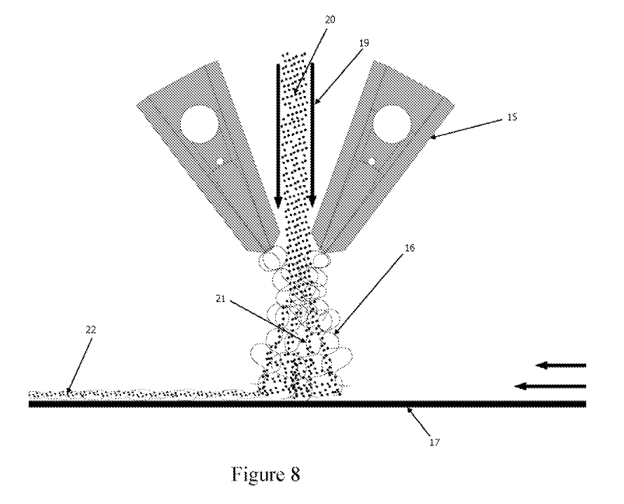

FIG. 8 shows how the fiber forming flow cells and spinning beams of this disclosure are ideally suited for creating nonwovens containing advantageously functional particulates. Two such spinning beams 15 are oriented such that the planar gas and fiber flows from each converge at a central point to form a single composite flow of gas and fibers. The spinning beams are close enough to one another such that the natural entrainment of ambient gas creates a strong aspirated gas flow 19. Particulates 20 are metered into the aspirated gas flow which conveys them to the zone of convergence of the spinning beam jets. The particulates are virtually all contained within and mixed with fibers in a turbulent mixing zone 21. The blend of particulates and fibers is deposited on a moving collector 17 to form a composite non woven 21.

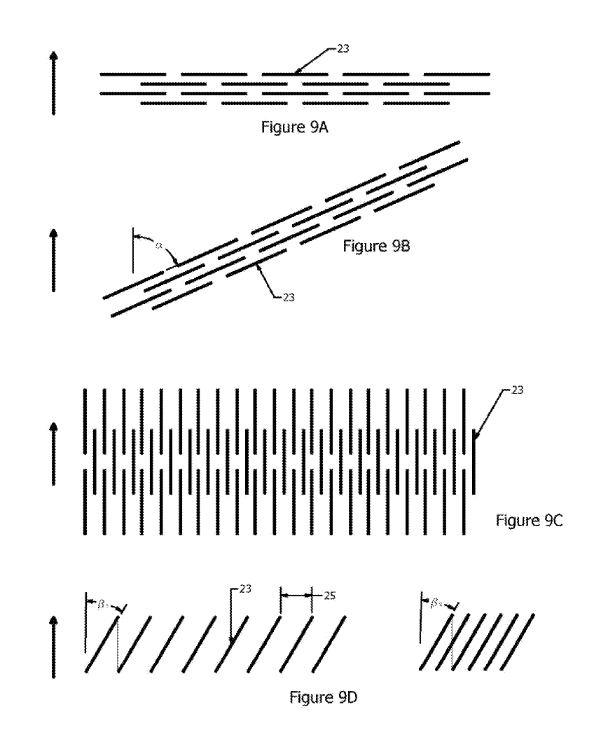

FIG. 9 shows possible flow channel orientations wherein in multi-channel spinning beams can be configured across a web forming collector moving in the direction of the arrows. Each line in each array schematically represents a flow channel exit plane 23 in plan view over a fiber collector. FIG. 9A shows the array similar to that of FIG. 7 wherein the composite flow fiber stream is substantially planar and oriented perpendicular to the direction of the moving collector 24. One skilled in the art will know that the configuration of FIG. 9A can be oriented relative to the machine direction of the collector at any angle, α, as shown in FIG. 9B. FIG. 9C shows a possible arrangement wherein the individual flow channels are oriented in the direction of collector movement, nevertheless the composite array is still substantially linear and oriented perpendicular to the collector. Again one skilled in the art would know that the over all array can be oriented at any angle to the direction of collector motion. FIG. 9D shows a possible configuration wherein each flow channel is oriented at an angle, β₁, β₂, to collector motion and positioned so that the gas and fiber streams issuing from each overlap in projection in the machine direction. In such a configuration natural gas dynamics will collapse the individual gas and fiber jets to a single substantially planar flow. One skilled in the art will know that varying the angle β and the nominal distance between flow cells, 25, provides advantageous control of the overlap between cells and hence fiber density issuing from the substantially linear spinning beam. This, in turn, controls the uniformity of fiber deposition and the spinning beam fiber production rate. Again the whole of the spinning beam comprising the configurations of FIG. 9D can be oriented at any angle with respect to collector motion.

The utility of the fiber forming flow channel of this disclosure is not limited to the examples presented above. Those skilled in the art will know that other configurations are possible depending on process and product requirements.

### Second Embodiment

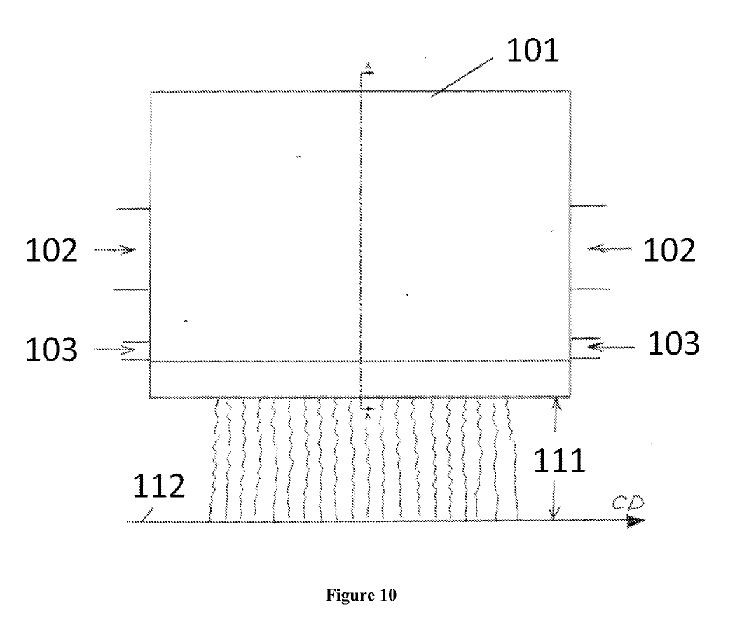

A second embodiment of the flow channel is illustrated in FIGS. 10, 11, and 12. Whereas the first embodiment employed a machined, contoured flow channel to force both the gas flow and the polymer film to spread in a direction transverse to the main flow direction, this embodiment spreads only the polymer film in a direction transverse to the main flow direction. In this embodiment the flow channels are adjacent and contiguous, forming a single plane surface. Transverse spreading of the polymer film is accomplished by separating the polymer feed orifices 7 sufficiently to allow the pressure of the accelerating gas stream squeeze and spread the polymer film transversely to the air flow direction. This embodiment is mechanically simple and easily configured as a fiber spinning beam spanning a conventional web forming fiber collector.

Process Description

A two-phase flow nozzle 101 for spinning fibers is positioned at a distance 111 relative to a collecting surface 112, as illustrated in FIG. 10. Nozzle 101 is shown parallel to the cross machine direction CD, although it could be positioned at any angle. Air is injected into the nozzle 101 through ports 102 and polymer is injected into nozzle 101 through ports 103.

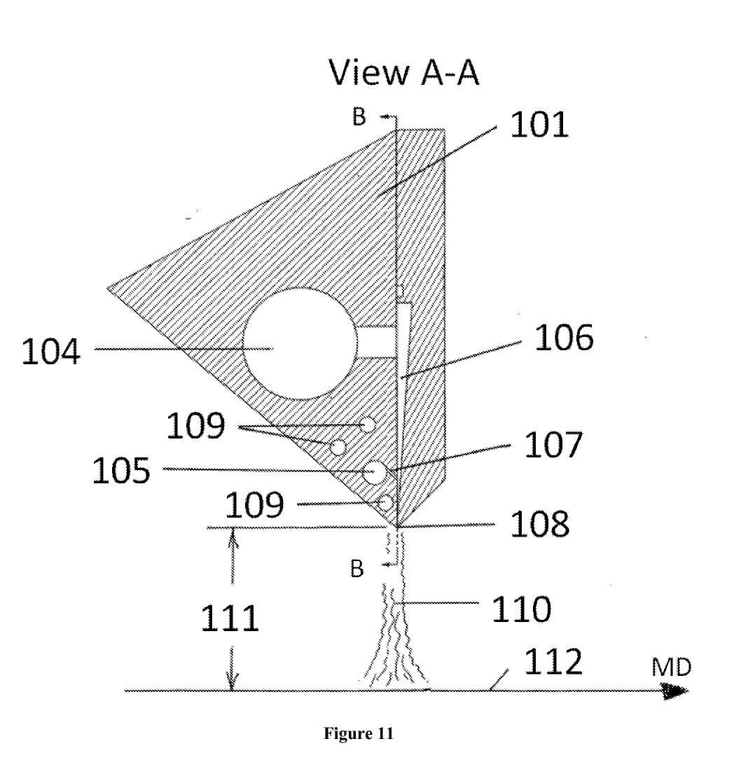

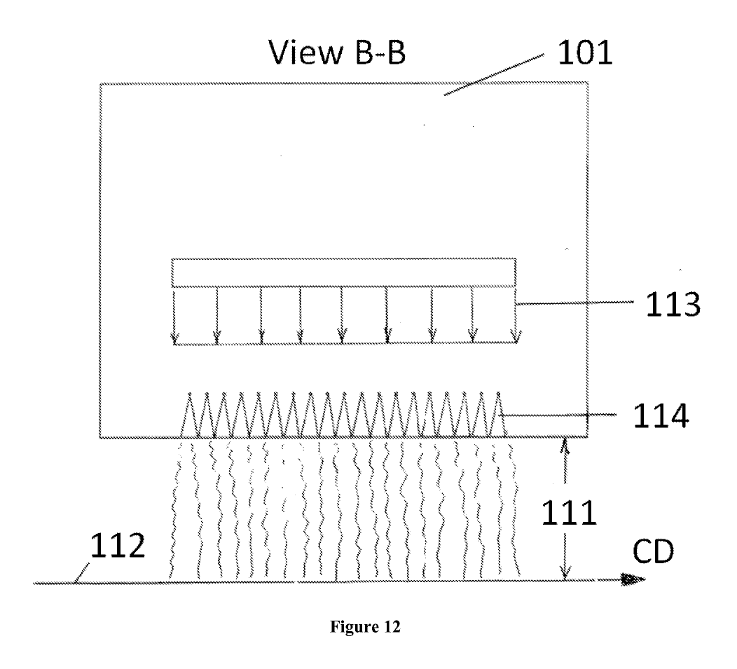

A cross-section view A-A of nozzle 101 is shown in FIG. 11. An air chamber 4 feeds air into monotonically converging channel 106 formed between the flow channel plate 1 and the flow channel lid. A polymer chamber 105 feeds polymer into orifices 107. Polymer from orifices 107 is injected into converging channel 106 where the air flow 113 (see FIG. 12) shears the polymer flows into films 114 (see FIG. 12). The films flow to the exit gap 108 of channel 106 where fibers 110 are formed outside the nozzle 101. The nozzle 101 is equipped with electrical heaters 109 which can be used to heat the surface over which films 114 flow.

Linear Array

Individual spinning nozzles extrude a substantially planar polymer thin film. These spinning nozzles may be readily configured in an array that can produce nanofibers uniformly across the width of a web forming apparatus. In an embodiment of the disclosure, the array is linear.

An embodiment of an apparatus (cross machine direction and throughput) for making nanofibers is shown in FIGS. 13, 14, 15, and 16. The apparatus can also spin one or two polymers and co-mingle them. The apparatus also has a heated wall capability for adjusting fiber size distribution characteristics.

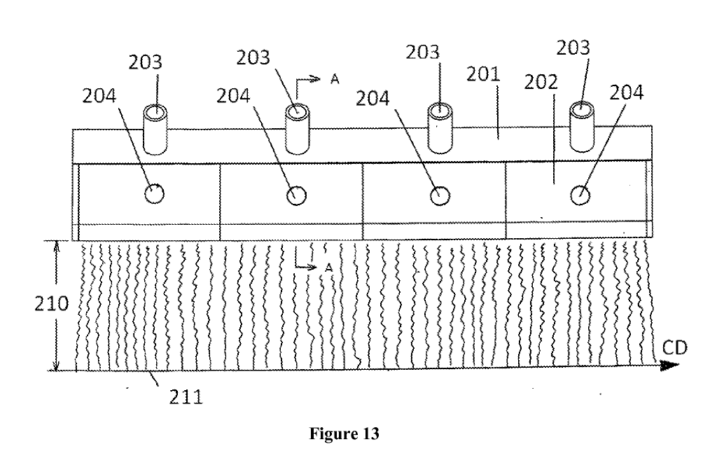

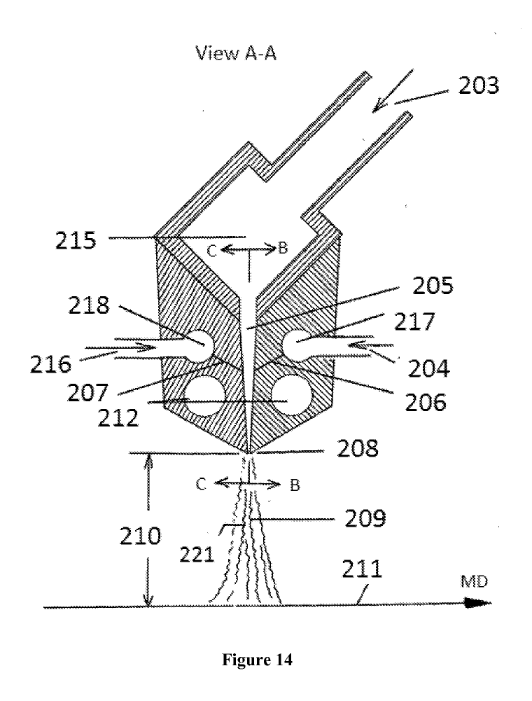

Nozzle 201 is located a distance 210 from a fiber collecting surface 211. Nozzle 201 is shown parallel to the cross machine direction; however it can be located at any angle. Nozzle 201 is comprised of modular sections such that the process width in the cross machine direction is scalable to a desired product width. Air is injected into chamber 215 through ports 203. Polymers are injected into chambers 217 and 218 through ports 204 and 216, respectively (see FIG. 14). Air from chamber 215 flows into converging channel 205 and then exits nozzle 201 through gap 208. Polymer from chamber 217 flows through orifices 206 into converging channel 205 where the polymer is sheared into a film 214 by air jet 213. Polymer from chamber 218 flows through orifices 207 into converging channel 205 where the polymer is sheared into a film 219 by air jet 220. Heaters 212 are used to control the temperatures of films 214 and 219. Fibers 209 are produced from film 214 and fibers 221 are produced from film 219. Fibers 209 and 221 are co-mingled and collected on surface 211.

The individual flow cell described above has proven highly efficient and capable of producing submicron fibers at a rate of 7.2 grams per minute and higher from a single polymer feed capillary. Multiple linear arrays of fiber forming cells can be used to meet or exceed conventional melt blowing throughputs. Multiple linear arrays of fiber forming cells can be used to meet economically required throughputs.

Edge Geometry

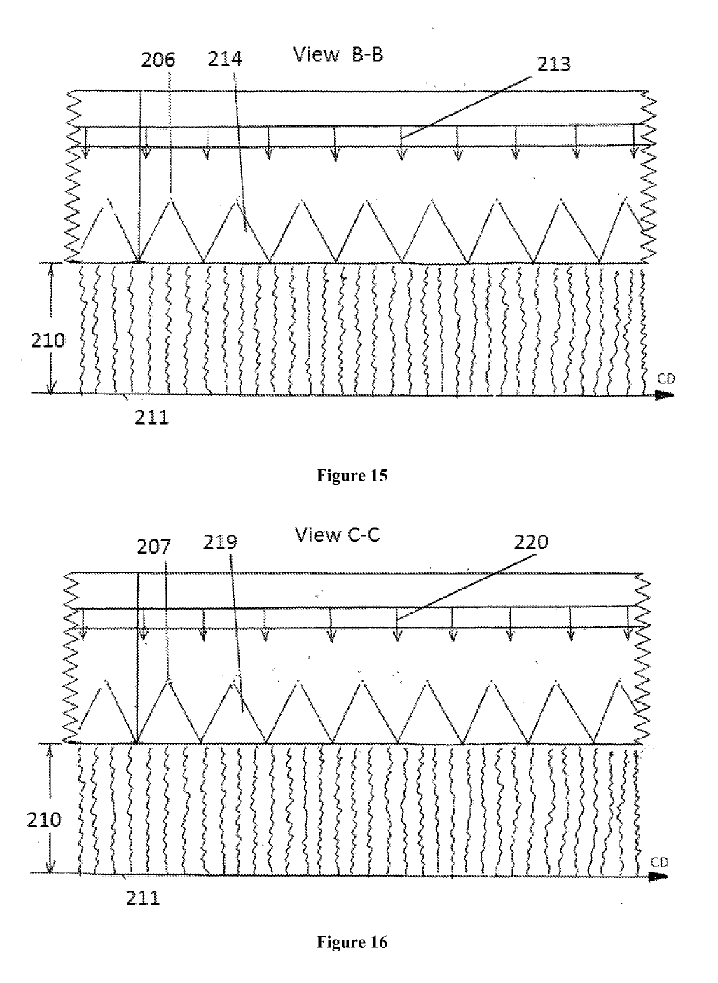

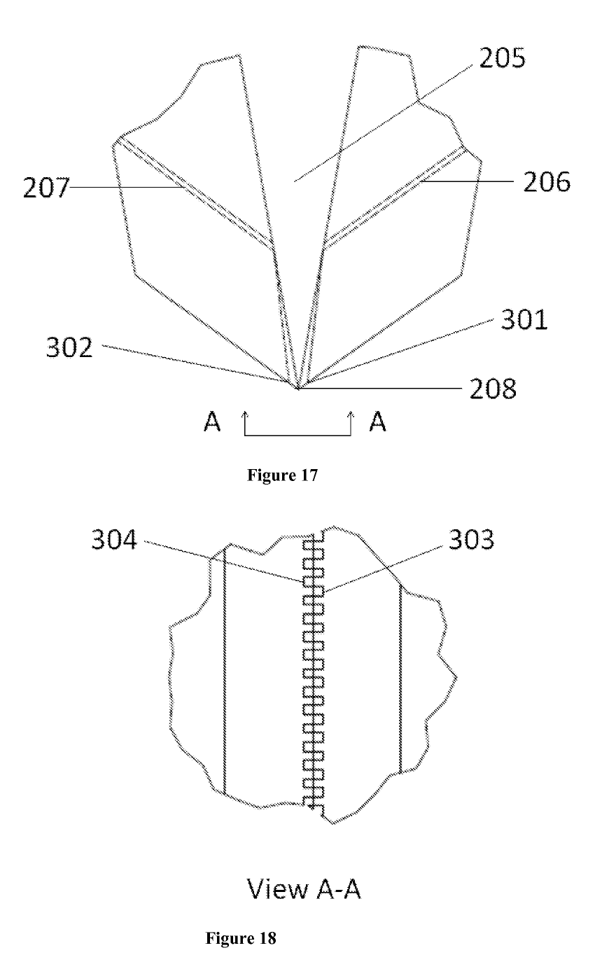

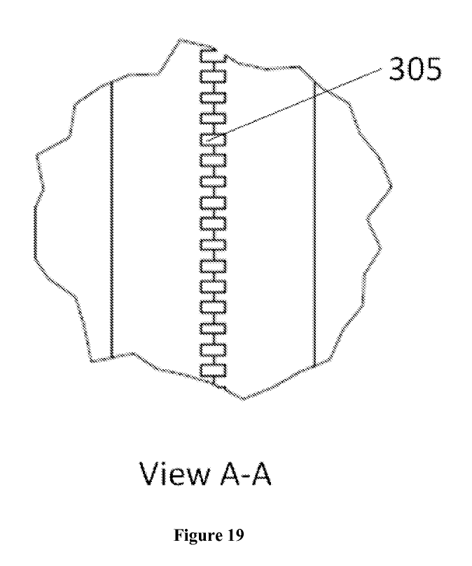

Various edge geometry configurations are illustrated in FIGS. 17, 18 and 19. FIG. 17 shows a cross-sectional view of a linear nozzle. The edge geometries 301 and 302 of gap 208 can be configured in a number of shapes. In one embodiment of the edge geometry the edges are smooth and straight in the cross/machine direction. The converging air channel 205 shears polymers from orifices 206 and 207 into films which flow over edges 301 and 302 at exit gap 208. FIGS. 18 and 19 show 2 configurations of edges 301 and 302. In FIG. 18, the edges are configured such that the polymer films flow through separate flow gaps 303 and 304. In FIG. 19, the edges are configured such that the polymer films flow through a common flow gap 305.

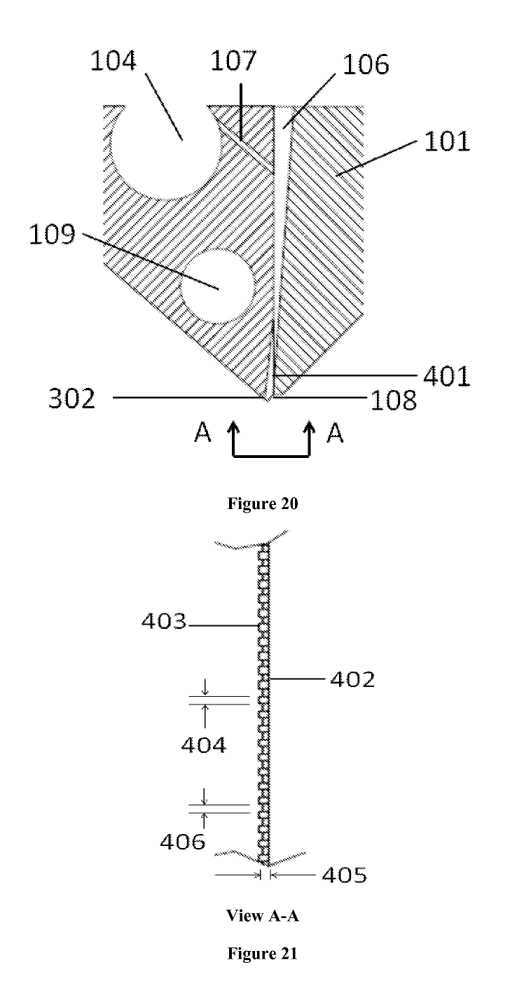

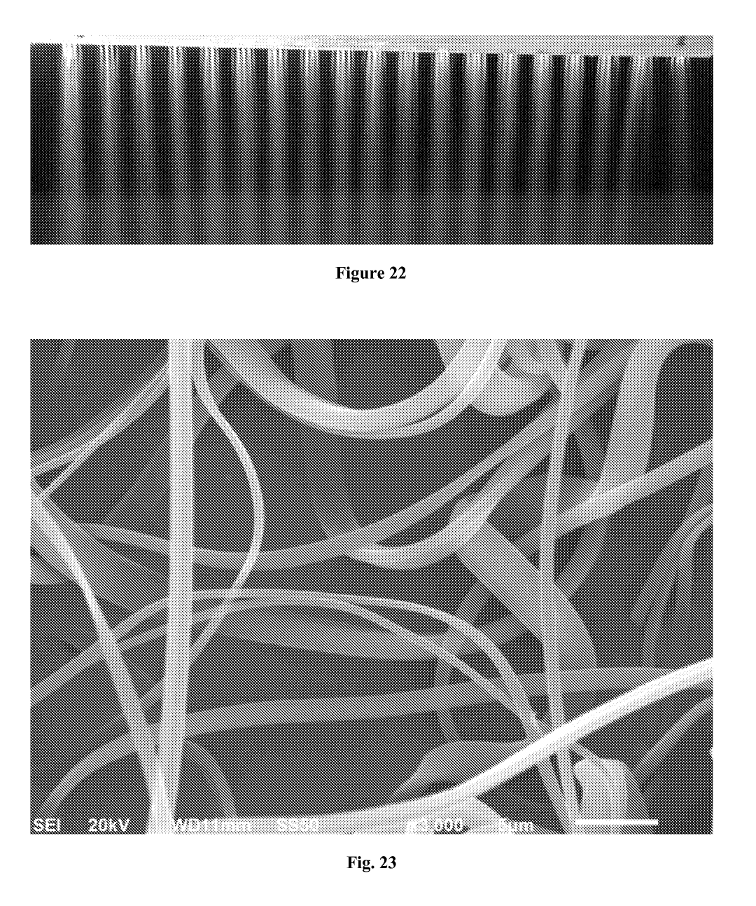

Other configurations of the edge geometry are illustrated in FIGS. 20, 21 and 22. The edge geometry 302 of gap 108 can be configured in a number of ways. In other embodiments the edge is shown as smooth and straight in the cross-machine direction. In FIG. 20 the edge geometry 302 is created by a series of diverging flow channels 401. In FIG. 21 the input flow channel 106 continues converging until it is closed by contact 402 at exit gap 108. This leaves openings 403 for the gas and polymer film flows to exit nozzle 101. FIG. 22 is a photograph illustrating a typical polymer/fiber flow pattern exiting gap 108.

### EXAMPLES

### Example 1

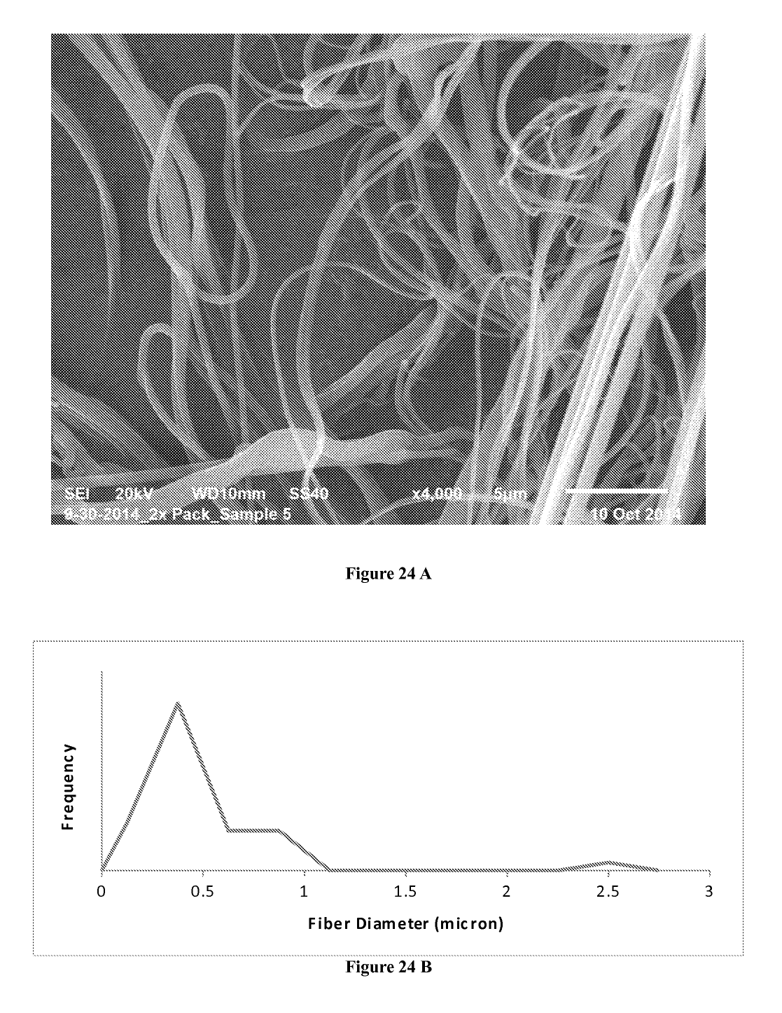

Atactic polypropylene (Sigma Aldrich Mw 12,000, Mn 5000) was fed to a 19 mm Brabender single screw melter, heated to 181 Deg C. and fed to a single flow channel of the two-phase flow nozzle of FIG. 10 through FIG. 12. Due to machining variances, the exit gap was approximately 0.13 mm. The polymer flow rate was 7.14 g/min. Heated air was supplied through a Sylvania 3500 watt air heater at approximately 5 ACFM and 268 Deg C. The nozzle temperature was approximately 245 Deg C. Fibers were produced and collected on a rotating drum collector at a collection distance of approximately 25 mm. Sizes of 27 fibers were measured: Fiber size Average, Standard Deviation, and Median were 0.51, 0.40, and 0.44 microns respectively. Fiber SEM's are shown in FIG. 24A and the fiber size distribution is shown in FIG. 24B.

### Example 2

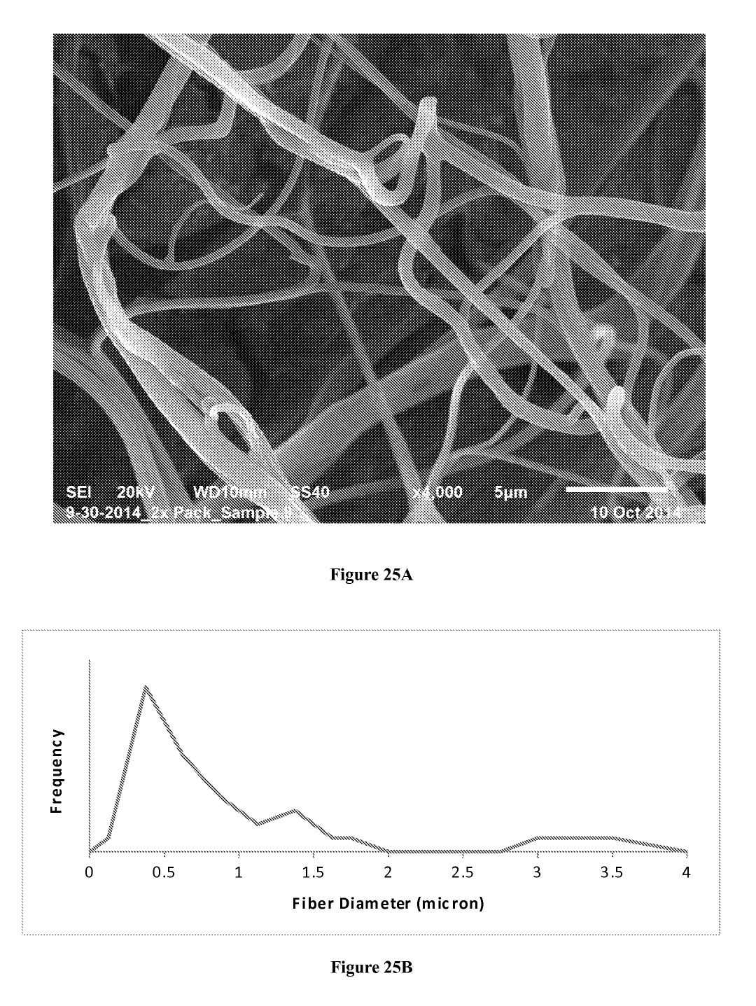

Atactic polypropylene (Sigma Aldrich Mw 12,000, Mn 5000) was fed to a 19 mm Brabender single screw melter, heated to 181 Deg C. and fed to a single flow channel of a two-phase flow nozzle of FIG. 10 through FIG. 12. Due to machining variances, the exit gap, was approximately 0.13 mm. The polymer flow rate was 13.7 g/min. Heated air was supplied through a Sylvania 3500 watt air heater at approximately 4 ACFM and 268 Deg C. The nozzle temperature was approximately 240 Deg C. Fibers were produced and collected on a rotating drum collector at a collection distance of approximately 25 mm. Sizes of 33 fibers were measured: Fiber size Average, Standard Deviation, and Median were 0.87, 0.74, and 0.63 microns respectively. Fiber SEM's are shown in FIG. 25A and the fiber size distribution is shown in FIG. 25B.

### Example 3

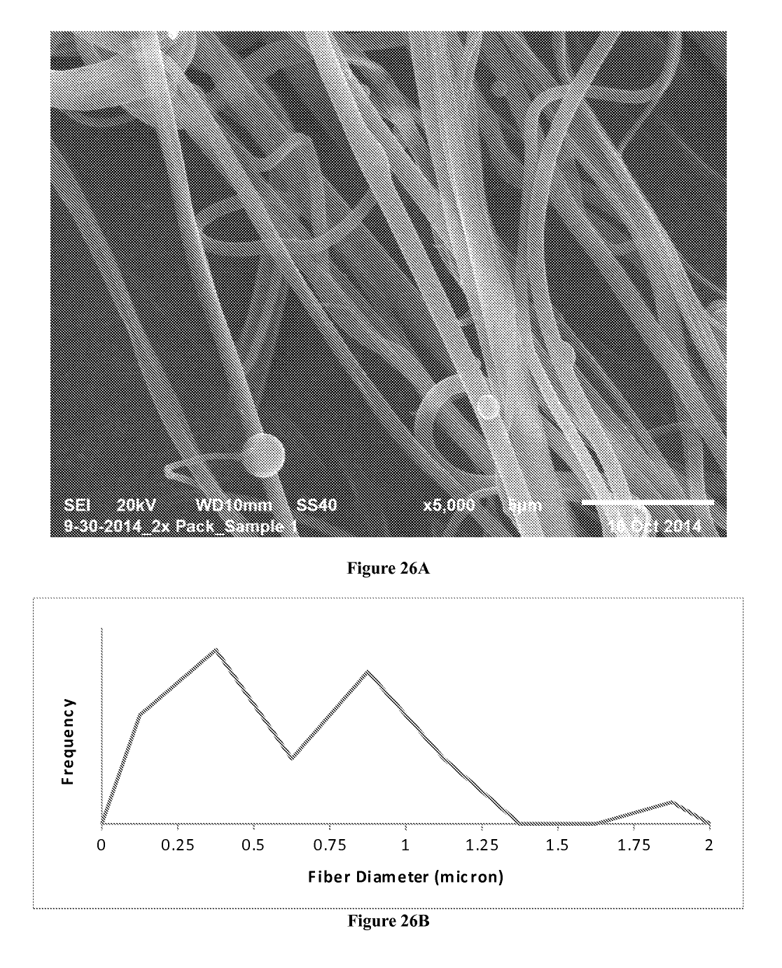

Atactic polypropylene (Sigma Aldrich Mw 12,000, Mn 5000) was fed to a 19 mm Brabender single screw melter, heated to 181 Deg C. and fed to a single flow channel of nozzle of FIG. 10 through FIG. 12. Due to machining variances, the exit gap was approximately 0.13 mm. The polymer flow rate was 1.44 g/min. Heated air was supplied through a Sylvania 3500 watt air heater at approximately 5.5 ACFM at 236 Deg C. The nozzle temperature was approximately 212 Deg C. Fibers were produced and collected on a rotating drum collector at a collection distance of approximately 25 mm. Fiber size Average, Standard Deviation, and Median were 0.65, 0.39, and 0.66 microns respectively. Fiber SEM's are shown in FIG. 26A and the fiber size distribution is shown in FIG. 26B.

### Example 4

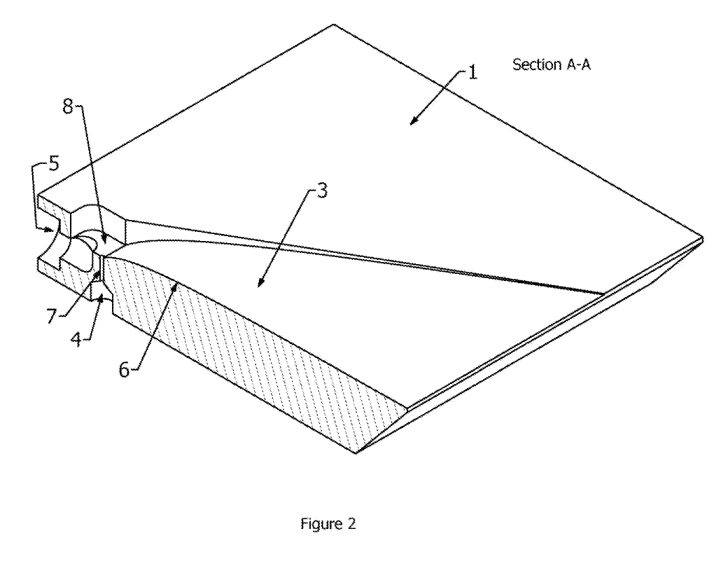

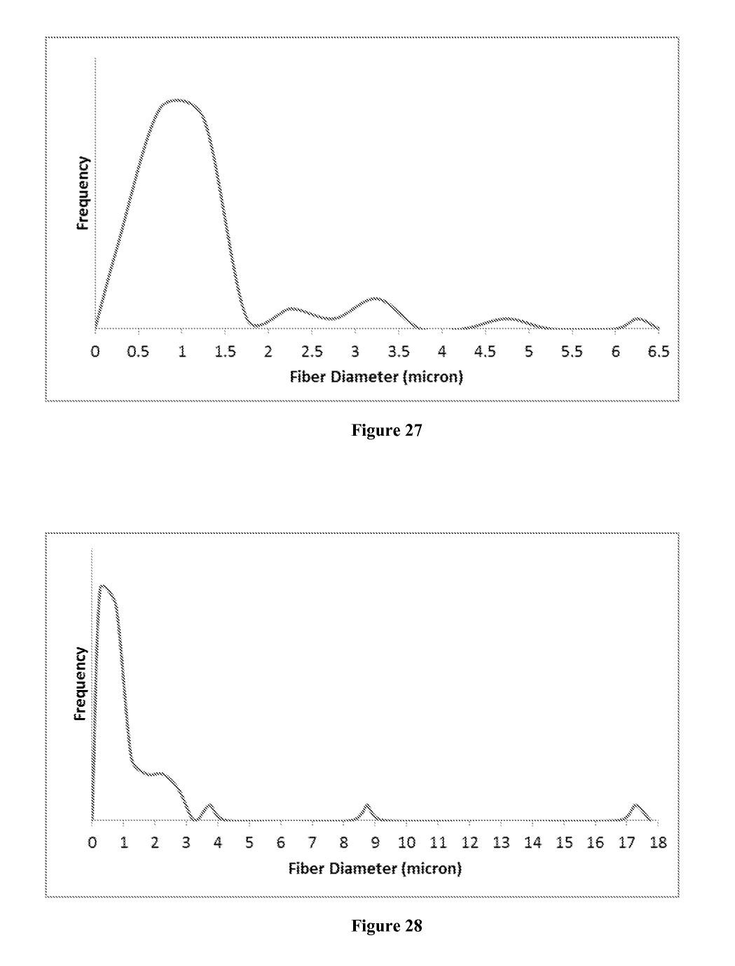

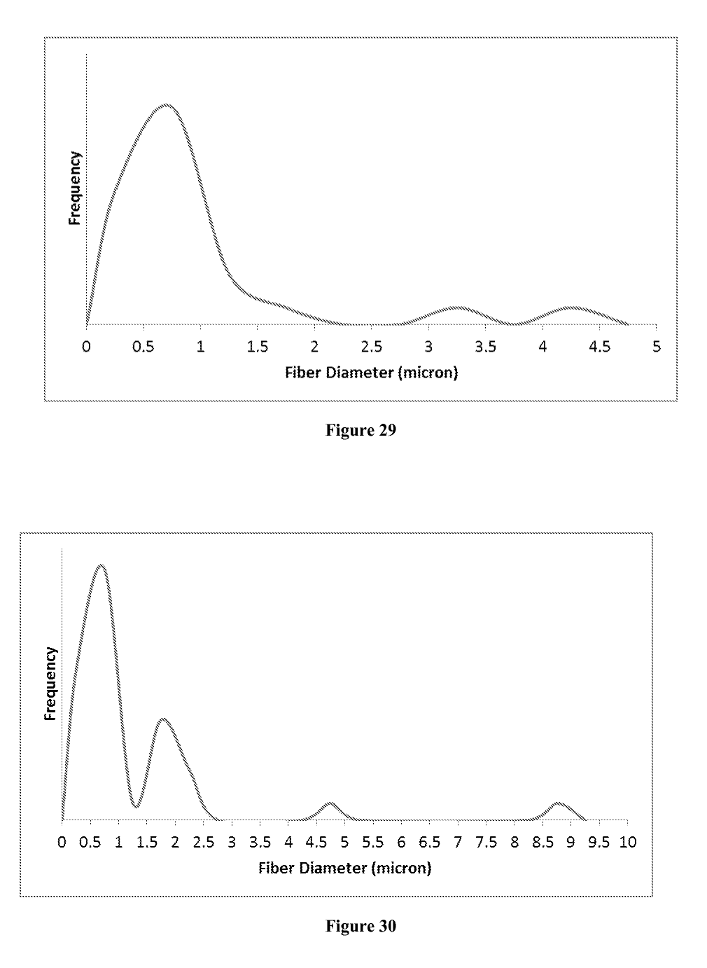

An extruder (¾ inch Laboratory Extruder from C. W. Brabender, Valley Forge, Pa.) was used to supply a polymer mixture to a spin nozzle having configuration 101 as shown in FIG. 1. As shown in FIG. 2, dimension 404 was 0.30 mm, dimension 405 was 0.36 mm, and dimension 406 was 0.30 mm. The polymer mixture was 40% by weight isotactic polypropylene with molecular weight 12,000 (Sigma Aldrich), 40% by weight isotactic polypropylene with molecular weight 30,000 (Marco Polo International, Cumming, Ga.), and 20% by weight atactic polypropylene BassFlex H1 (BassTech International, Fort Lee, N.J.). The polymer temperature at the extruder exit was 193 C and the polymer pressure at the extruder exit was 8.6 bars. The polymer mixture was injected into nozzle 101 through two ports 103. Heated air was injected into nozzle 101 through two ports 102 at 265 C. The air flowrate was 0.21 cubic m per minute as measured at 3.8 bars using a King rotameter (part no. 7510217A05). The nozzle 101 had nineteen polymer feed orifices 107 spaced 0.38 cm apart in the CD and located 0.95 cm from exit gap 108. Heaters 109 were used to heat nozzle 101 to various temperatures and fiber samples were collected. SEM pictures of the samples were used to estimate the fiber size distributions. FIGS. 27, 28, 29, and 30 show the fiber size distribution estimates for samples collected with the nozzle 1 at temperatures 269 C, 295 C, 313 C, and 314 C, respectively. Table 1 gives the median, average, and standard deviation of the fiber size distribution based on nozzle and process air temperature.

TABLE 1
Fiber Size Distribution

| | | | | Standard |
|---|---|---|---|---|
| Nozzle Temp | Air Temp | Median Size | Average Size | Deviation |
| C. | C. | microns | microns | microns |
| 269 | 265 | 1.0 | 1.3 | 1.0 |
| 295 | 266 | 0.7 | 1.5 | 2.8 |
| 313 | 242 | 0.7 | 0.9 | 0.9 |
| 314 | 211 | 0.7 | 1.2 | 1.5 |

1. A two-phase flow nozzle for forming and fibrillating a molten polymeric film into nanofibers comprising
one or more first input orifices for a process gas;
one or more second input orifices for a polymer melt;
a flow channel comprising two or more channel walls and a monotonically decreasing flow area wherein the process gas and polymer melt are combined into a stratified two phase flow with the polymer melt formed into a film on one or more of the channel walls; and
one or more channel exit openings, each exit opening comprising an edge at which the process gas reaches sonic velocity or less and wherein the edge is configured to fibrillate the polymeric film into a stream of nanofibers.

2. The nozzle of claim 1 wherein spacing of the polymer input orifices is configured so as to spread the polymer film in a direction transverse to polymer flow direction as well as in the polymer flow direction, thereby thinning the film.

3. The nozzle of claim 2 wherein flow channel geometry is configured to spread the film over an angle greater than thirty degrees.

4. The nozzle of claim 1 where one or more of the walls is heated.

5. The nozzle of claim 1 where one or more channel exit openings comprises grooves configured to split the polymer film into a plurality of individual polymer streams.

6. The nozzle of claim 1 wherein the channel exit opening increase wetted polymer flow area further thinning the polymer film by geometrical modifications comprising grooves, sawtooths, sinusoids, ellipsoids, square waves, rectangular waves, pulse waves and triangular waves.

7. The nozzle of claim 6 wherein nanofibers geometry is not circular.

8. An apparatus for forming and fibrillating a molten polymeric film into nanofibers comprising a plurality of two-phase flow spinning nozzles arranged in a substantially liner array each nozzle comprising
one or more first input orifices for a process gas;
one or more second input orifices for a polymer melt;
a flow channel comprising two or more channel walls and a monotonically decreasing flow area wherein the process gas and polymer melt are combined into a stratified two phase flow with the polymer melt formed into a film on one or more of the channel walls; and
one or more channel exit openings, each exit opening comprising an edge at which the process gas reaches sonic velocity or less and wherein the edge is configured to fibrillate the polymeric film into a stream of nanofibers.

9. The apparatus of claim 8 where mass ratio of air flow rate to polymer flow rate required to produce nanofibers is less than about 50.

10. The apparatus of claim 8 where nanofibers are produced at a rate of at least 1 gram per minute per centimeter.

11. The apparatus of claim 8 further comprising a moving surface positioned at a set distance from the exit opening edge of the flow channel for collecting the nanofibers.

12. (canceled)

13. (canceled)

14. (canceled)

15. (canceled)

16. (canceled)

17. (canceled)

18. (canceled)

19. (canceled)

20. (canceled)
